(19) United States
(12) Patent Application Publication
(10) Pub. No.: US 2017/0277720 A1
(43) Pub. Date: Sep. 28, 2017

(54) DEVICES, SYSTEMS, AND METHODS FOR DIGITAL IMAGE SEARCHING

(71) Applicants: Canon Canada Inc., Mississauga (CA); Canon U.S.A., Inc., Melville, NY (US)

(72) Inventors: John Rockefeller, Waterloo (CA); Rajan Joshi, Brampton (CA); Bankole Adebajo, Waterloo (CA)

(21) Appl. No.: 15/467,970

(22) Filed: Mar. 23, 2017

Related U.S. Application Data
(60) Provisional application No. 62/314,259, filed on Mar. 28, 2016.

(51) Int. Cl. G06F 17/30

(52) U.S. Cl. CPC G06F 17/30268; G06F 17/30274; G06F 17/30991

(57) ABSTRACT

A method and apparatus for searching digital images is provided and includes receiving a first search query, determining a first set of digital images based on the contents of the first query, displaying the digital images returned based on the results of the first query, receiving a second query different from the first query, determining a second set of digital images based on the contents of the first query and the second query, and displaying the digital images returned based on the results of the first query and second query.

### BACKGROUND

Technical Field

This description generally relates to image searching, and more particularly to context-based image search.

Description of Related Art

Searching for images in one's personal digital image library is usually done manually by scrolling through a file system, looking through grouped digital images, etc., for the desired digital image(s). This method of searching can be cumbersome and time consuming, especially when there are a large number of digital images, as well if some time has passed since some of the digital images were taken. Currently, there are services that enable users to locate digital images based on tags associated with a digital image that include information such as location of where the digital image was taken, the date a digital image was taken, etc. However, there is no simple mechanism for a user to automatically locate digital images based on multiple tags associated with a digital image.

### SUMMARY

In at least one exemplary embodiment, a method for searching digital images includes receiving a first search query, determining a first set of digital images based on the contents of the first query, displaying the digital images returned based on the results of the first query, receiving a second query different from the first query, determining a second set of digital images based on the contents of the first query and the second query, and displaying the digital images returned based on the results of the first query and second query.

In at least one exemplary embodiment, the search method further includes determining the first set of digital images includes selecting, from a storage device, a set of images from a plurality of stored images each having at least one characteristic associated therewith that matches at least one term of the first search query.

In at least one exemplary embodiment, the search method further includes determining the second set of digital images includes selecting from the first set of digital images, images having at least one additional characteristic associated therewith that matches at least one term of the second search query.

In at least one exemplary embodiment, each digital image includes at least one characteristic associated therewith and further includes a confidence value indicating a degree of accuracy with which the at least one characteristic describes a context of each image and, determines the first set of images by comparing the first search query with the at least one characteristic associated with each digital image and selecting, for the first set of images, digital images having the at least one characteristic with a confidence value equal to or greater than a predetermined threshold.

In at least one exemplary embodiment, the search method further includes determining the second set of images by comparing the second search query with the at least one characteristic associated with each digital image of the first set of images and selecting, for the second set of images, digital images having the at least one characteristic with a confidence value equal to or greater than a predetermined threshold.

In at least one exemplary embodiment, the search method further includes automatically selecting from the second set of images an further set of images in response to receipt of a further search query, wherein the further search query includes the first and second search queries, and continually updating the displayed images in the user interface to include the further set of images each time a further search query is received.

In at least one exemplary embodiment, the search method includes deleting, at least one term from at least one of the first search query and second search query, determining a further set of images by deleting, from the first and second set of images, images having an image characteristic corresponding to the deleted at least one term, and displaying the further set of images.

In at least one exemplary embodiment, the search method includes determining the first set of images includes, searching at least one data file stored in memory using at least one term of the first search query. The at least one data file includes an image identifier associated with each of the stored images that identifies an image and a location of an image in a storage device; and at least one image tag corresponding to at least one characteristic of the stored image. At least one image is selected for the first set of images in response to determining that the at least one term of the first search query matches one of the at least one image tags, and, for each image selected for the first set of images, storing, in memory, the image identifier and the at least one image tag associated with the selected image.

In at least one exemplary embodiment, the search method includes displaying the first set of images includes, generating, for each image selected for the first set of images, a thumbnail of the selected image, the generated thumbnail including the image identifier and the at least one image tag enabling a user to select the generated thumbnail for full size display using the image identifier.

In at least one exemplary embodiment, the search method includes determining the second set of images by searching the memory including the image identifiers and at least one image tags of each image selected for the first set of images, and selecting an image for the second set of images in response to determining that the at least one term of the second search query matches one of the at least one image tags of an image in the first set of images.

In at least one exemplary embodiment, a non-transitory computer readable medium is provided. The non-transitory computer readable medium stores instructions that, when executed by at least one processor, controls the processor to perform operations including receiving a first search query; determining a first set of digital images based on the contents of the first query; displaying the digital images returned based on the results of the first query; receiving a second query different from the first query; determining a second set of digital images based on the contents of the first query and the second query; and displaying the digital images returned based on the results of the first query and second query.

In at least one exemplary embodiment, an apparatus is provided and includes memory storing instructions, and at least one processor that, upon execution of the stored instructions is controlled to perform operations including receiving a first search query; determining a first set of digital images based on the contents of the first query; displaying the digital images returned based on the results of the first query; receiving a second query different from the first query; determining a second set of digital images based on the contents of the first query and the second query; and displaying the digital images returned based on the results of the first query and second query.

### BRIEF DESCRIPTION OF THE DRAWINGS

FIG. 1 illustrates an exemplary embodiment of a system for searching digital images.

FIG. 2 illustrates an exemplary embodiment of the flow of user login and authentication to use image search services.

FIG. 3 illustrates an exemplary embodiment of the flow of selecting a digital image storage location.

FIG. 4 illustrates an exemplary embodiment of organizing digital images to be searched.

FIG. 5 illustrates an exemplary embodiment of the flow of generating digital image thumbnails.

FIG. 6 illustrates an exemplary embodiment of process flows associated with searching digital images.

FIG. 7 illustrates an exemplary embodiment of the flow of displaying results of a search query.

### DESCRIPTION

The following disclosure describes certain exemplary embodiments. Other exemplary embodiments may include alternatives, equivalents, and modifications. Additionally, the exemplary embodiments may include several novel features, and a particular feature may not be essential to some embodiments of the devices, systems, and methods that are described herein. As used herein, the conjunction “or” generally refers to an inclusive “or,” though “or” may refer to an exclusive “or” if expressly indicated or if the context indicates that the “or” must be an exclusive “or.”

The system of the below described exemplary embodiments improves the results of digital image searching.

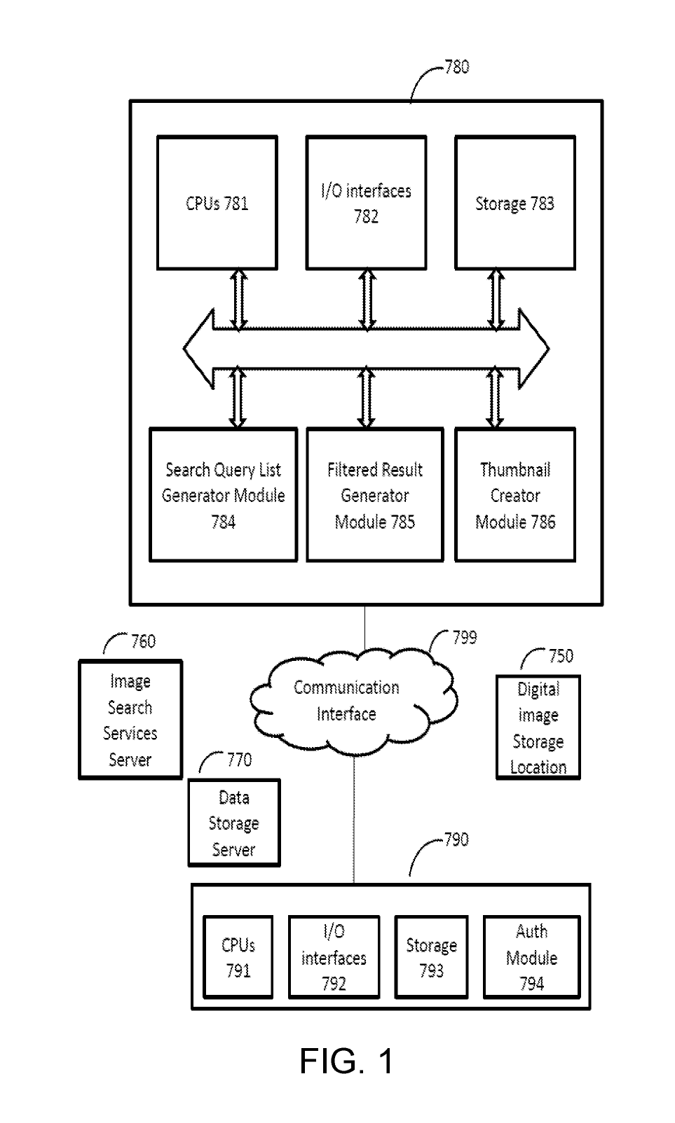

FIG. 1 illustrates an exemplary embodiment of a system for searching digital images. The system includes a client device 780 an authentication server 790, a data storage server 770, an image search services server 760 (hereinafter referred to as “search server 760”), and a digital image storage location 750. Client device 780, authentication server 790, data storage server 770, and search server 760 can communicate with each other via communication interface 799, which includes, but is not limited to, a wired network, a wireless network, a LAN, a WAN, a MAN, and PAN, etc. In the present exemplary embodiment, each of the above listed servers is a separate entity. However, in additional exemplary embodiments, any combination of the three can be combined into a single entity, e.g., data storage server 770 and search server 760 are a single physical entity. In the present exemplary embodiment, client device 780 is a personal computer. However, client device 780 is not limited to being implemented as a personal computer, and any other client device, e.g., smartphone, tablet, etc., that would enable practice of the exemplary embodiment(s) is applicable.

Client device 780 includes one or more processors (CPUs) 781, one or more I/O interfaces 782, and storage 783. The CPUs 781 include one or more central processing units, which include microprocessors (e.g., a single core microprocessor, a multi-core microprocessor) or other circuits, and the CPUs 781 are configured to read and perform computer-executable instructions, such as instructions that are stored in storage 783 or any other type of memory. The I/O interfaces 782 include communication interfaces to input and output devices, which may include a keyboard, a display, a mouse, a printing device, a touch screen, a light pen, an optical-storage device, a scanner, a microphone, a camera, a drive, a controller, and a network (either wired or wireless).

The storage 783 includes one or more computer-readable or computer-writable media, for example a computer-readable storage medium. As used herein, a transitory computer-readable medium refers to a mere transitory, propagating signal per se, and a non-transitory computer-readable medium refers to any computer-readable medium that is not merely a transitory, propagating signal per se. Also, a computer-readable storage medium, in contrast to a mere transitory, propagating signal per se, includes a tangible article of manufacture, for example a magnetic disk (e.g., a floppy disk, a hard disk), an optical disc (e.g., a CD, a DVD, a Blu-ray), a magneto-optical disk, magnetic tape, and semiconductor memory (e.g., a non-volatile memory card, flash memory, a solid-state drive, SRAM, DRAM, EPROM, EEPROM). The storage 783, which can include both ROM and RAM, can store computer-readable data or computer-executable instructions.

Client device 780 also includes a search query list generator module 784, a filtered result generator module 785, and a thumbnail creator module 786. The search query list generator module 784 generates search query lists based on at least one search query that enable searching for digital images. Filtered result generator module 785 generates filtered results of the search query lists. Thumbnail creator module 786 creates thumbnails of digital images included in the filtered results provided by the filtered result generator module 785. These modules are provided to client device 780 by search server 760 as described below.

The authentication server 790 includes one or more processors (CPUs) 791, one or more I/O interfaces 792, and storage 793. Because the functions of these entities are similar to those in client device 780, their descriptions are omitted herein. The authentication server 790 further includes auth module 794, which includes instructions that, when executed, or circuits that, when activated, enables the authentication server 790 to authenticate users. Search server 760 hosts the image search service of the present exemplary embodiment.

Digital image storage location 750 stores a user's digital images. This is typically provided by a third party, e.g., Dropbox ®, Google Drive®, iCloud, etc., In order to store and then later access digital images on the digital image storage location 750, a user typically generates an account on the digital image storage location 750, along with login credentials to be used to access the account. Data storage server 770 stores user digital images obtained from the digital image storage location 750, as well as additional information associated with the digital images, such as tag information, etc. Data stored on data storage server 770 is not limited to digital images/digital images related information.

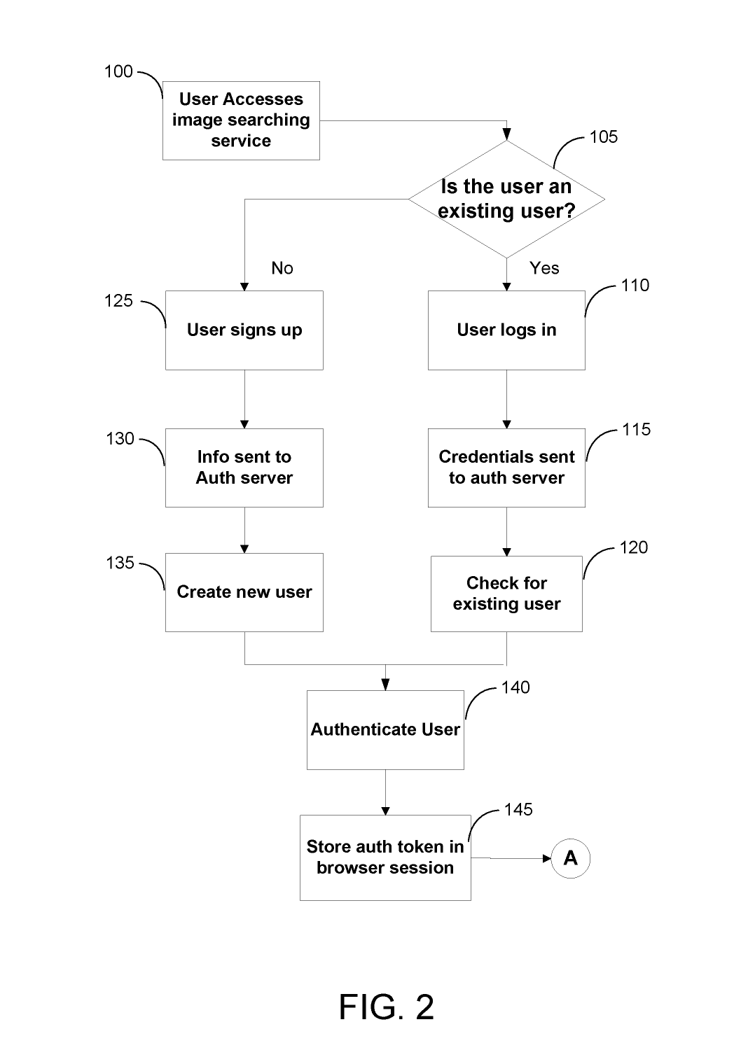

FIG. 2 illustrates an exemplary embodiment of the flow of a user accessing search server 760 in order to make use of the image search services. The term “user” in the following exemplary embodiment(s) refers a human being as the entity initiating/carrying out certain operations and/or actions. However, the present disclosure is not limited to a human being as the entity initiating these operation and/or actions. In another exemplary embodiment, any type of entity, e.g., a computer, capable of initiating the operations and/or actions, is applicable.

First, in block 100, a user launches an Internet browser on client device 780 in order to accesses a website of the image searching service that is hosted on search server 760. This is accomplished, for example, by entering a Uniform Resource Locator (URL) of the image search service website in the browser's URL field. Then, in block 105, the user, based on whether the user had previously accessed and registered with the image searching service, will either attempt to login into (block 110) or attempt to sign-up up with (block 125) the image searching service. In another embodiment, the operations of block 100 may be performed by a dedicated application executing on the client device 780. In this embodiment, the dedicated application may include a native web browser that allows a user to access the website of the image searching service. Alternatively, the dedicated application may automatically load an access page for accessing the image searching service.

If the user previously accessed and registered, i.e., created an account, with the image searching service, then in block 110, the user attempts to log into the user's image searching service account by providing the user's login/authentication credentials (hereinafter referred to as “credentials”). Typically, the user's credentials are a username and password provided at the time the user generated the user's account. However, any other methods of uniquely identifying a user that enable practice of aspects of the present exemplary embodiment are applicable. For purposes of the present disclosure, username and password will be used as the credentials. In an embodiment where the operations are performed by a dedicated application, the operation of block 110 may be performed upon initiation of the application whereby a credential access screen is displayed and enables a user to enter login credentials to access the system. In certain embodiments, the login operation described in block 110 may be performed concurrent with or before the operations in block 100.

After the user provides the user's credentials, search server 760 sends the credentials to authentication server 790 in block 115. Then, in block 120, the authentication server 790 verifies whether the user associated with the provided credentials is an existing user. Typically, this is accomplished by comparing the provided username with a list of registered usernames associated with existing users that are stored either in the authentication server 790 or in a separate storage location the authentication server 790 can access. This is just one example of verifying whether the provided credentials are associated with an existing user, and any other methods that would enable practice of aspects of the present exemplary embodiment are applicable. If the user is determined to be an existing user, flow proceeds to block 140, which is described below. If the use is not determined to be an existing user, authentication server 790 notifies search server 760, and search server 760 notifies the user that the user is not a registered user and the login attempt has failed (not shown).

If the user did not previously access and register with the image searching service, then in block 125, the user initiates a process for signing up/registering with the image searching service. In block 130, the user provides the information required to register with the image searching service, including the user's credentials, and the search server 760 forwards this information to the authentication server 790. Typically, the user is prompted to provide various types of identification related information. Upon receipt of the required information, in block 135, the authentication server 790 generates a new user account based on the received required information. Flow then proceeds to block 140.

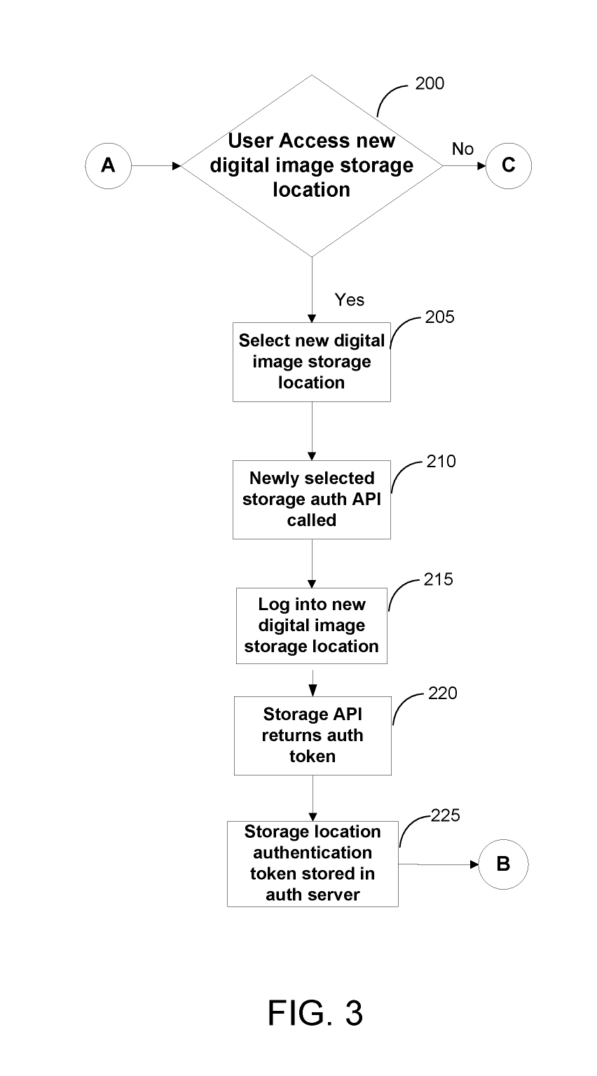

In block 140, authentication server 790 authenticates the user. This is typically performed by comparing the credentials provided by the user against stored credentials. However, any other methods for authenticating a user that would enable practice of aspects of the present exemplary embodiment are applicable. If the user is successfully authenticated, flow proceeds to block 145, where authentication server 790 generates an authentication token, provides it to search server 760, and search server 760 provides it to client device 780, where is it stored in the user's browser session. Flow then proceeds to block 200 in FIG. 3. If the user authentication fails, the user is notified of the failure (not shown).

The operations described above in steps 110, 115 and 120 or those in steps 125, 130 and 135, 140 and 145 operate in the same manner whether the user is accessing the system via a web browser or whether the user is using a dedicated application for accessing the system. Additionally, the operations described hereinafter with respect to FIGS. 3-7 also operate similarly whether the system is accessed via browser or dedicated application unless otherwise noted.

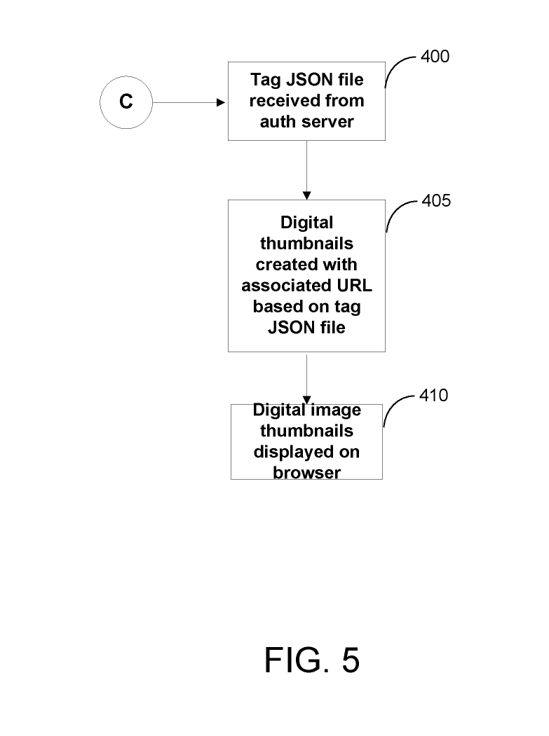

FIG. 3 illustrates an exemplary embodiment of selecting a new digital image storage location 750. In block 200, if the user does not decide to access a new digital image storage location, (200=No), flow moves block 400 in FIG. 5, which is described below.

If the user decides to access a new digital image storage location (200=Yes), then the flow moves to block 205 where the user selects a source where the user's digital images are stored and can be retrieved from. The user is provided with a list of locations, e.g., Dropbox®, Google Drive®, iCloud, etc., from which to select the source.

In the present exemplary embodiment, the list is pre-populated with current storage locations. The list can be modified by the user as needed (not shown). In another exemplary embodiment, the user enters the URL associated with the storage location the user wishes to access from the browser on client device 780. For discussion purposes, hereinafter, digital image storage location 750 will be referred to as the source of the digital images.

Upon the selection in block 205, in block 210, the selected digital image storage location enables the user to initiate the process for signing up/registering with the digital image storage location and the services it provides. This process is similar blocks 125, 130, 135 discussed above, and as such a detailed description is omitted herein.

Next, after registering with the new digital storage location, in block 215, the user attempts to log into the new digital image storage location. This block is similar to blocks 115, 120, and 140 described above, and as such, detailed descriptions are omitted herein.

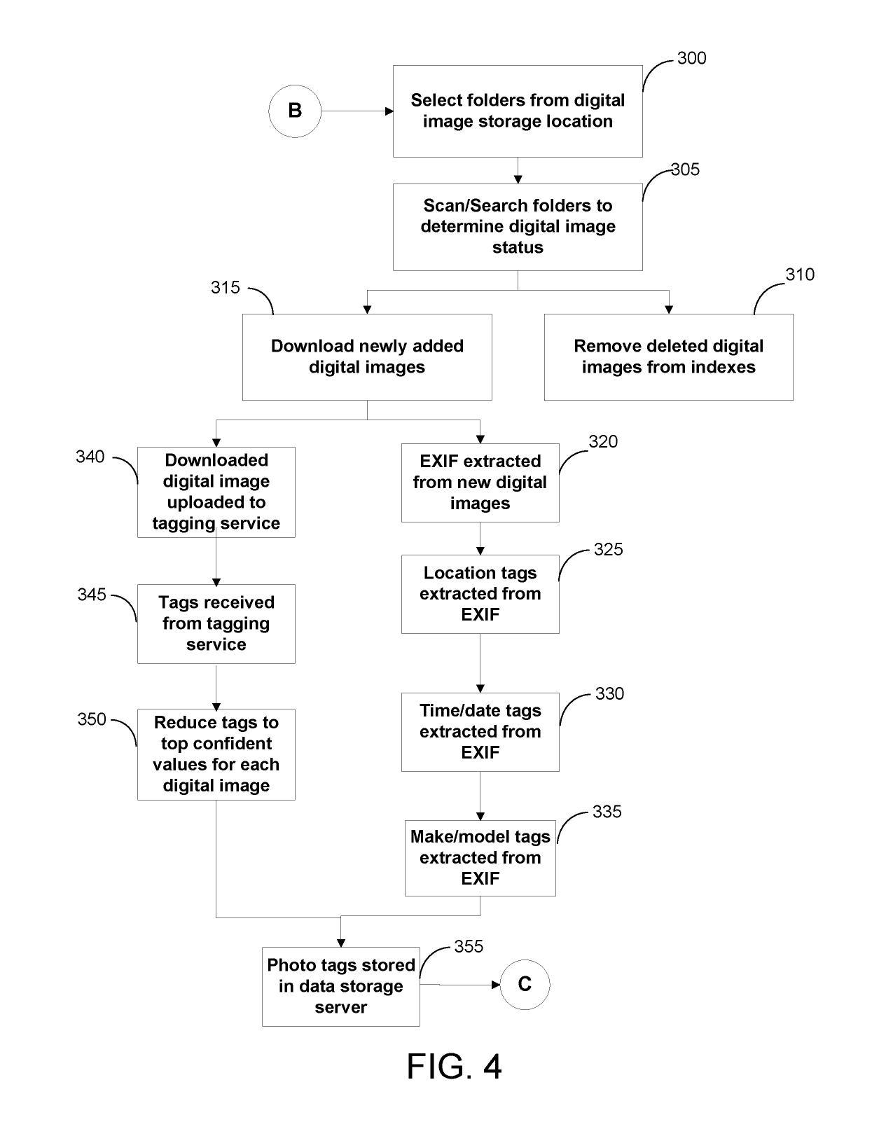

If the user is able to successfully log into the new digital image storage location, in block 220, the digital image storage location's authentication application program interface (API) returns an authentication token for the selected digital image storage location to the client device 780. In block 225, the returned digital image storage location authentication token is then saved in authentication server 790. Flow then proceeds to block 300 in FIG. 4.

FIG. 4 illustrates an exemplary embodiment for organizing digital images to be searched. Typical digital image storage locations store digital images in folders. As such, for discussion purposes, reference will be made to these folders. However, any digital image organizational method that would enable practice of aspects of the present disclosure is applicable.

Turning to block 300 in FIG. 4, the user selects one or more folders in the digital image storage location 750 in which an image search is to be performed. Then, in block 305, the selected folders are scanned/searched to determine the status of the digital images located in each of the selected folders. This includes determining if any new digital images have been added to any of the selected folders and/or if any digital images have been removed from any of the selected folders. The scanning/searching and determination of newly added or deleted digital images is done using known methods, and as such, a detailed description is omitted herein. The scanning/searching can be performed periodically to maintain an up-to-date status of the contents of each of the selected folders.

Next, in block 315, any digital images determined in block 305 to be newly added are downloaded from the digital image storage location 750 and saved in data storage server 770.

In addition to the above described process of block 315, in block 310, any digital images that were determined to have been removed from the selected folders are removed from any indexes of digital images maintained by the data storage server 770.

After the newly added digital images are downloaded to data storage server 770 in block 315, the flow advances to blocks 340 and 320. The process of blocks 340, 345, and 350 are performed by a digital image tagging service. In the present exemplary embodiment, the digital image tagging service is located outside the system of the present disclosure. However, in another exemplary embodiment, the digital image tagging service can be included in the system of the present disclosure. The process of blocks 320, 325, 330, and 335 are performed by the image search services of the present disclosure.

Turning to block 340, the digital images downloaded to data storage server 770 are uploaded to the digital image tagging service. Upon receipt of the digital images, the digital image tagging service generates one or more tags for each of the digital images based on the content of the respective digital image using known techniques (detailed description omitted herein). In block 345, the digital image tagging service sends the generated tags to the data storage server 770.

Each tag includes a confident value indicating the level of relevancy of the tag to its associated digital image. In block 350, if the number of tags received from the digital image tagging service exceeds a predetermined number of tags, e.g., 10, the number of tags is reduced to the predetermined number that reflect the top confident values. For example, the digital image tagging service returns five tags, with confident values of 65, 18, 93, 47, and 24 respectively for a digital image and the predetermined number of tags is three. The five tags will be reduced to the three tags with the three highest confident values, i.e., the tags with confident values 93, 65, and 47. The process then proceeds to block 355, which is described below.

Turning to block 320, the data storage server 770 extracts Exchangeable Image File Format (EXIF) data from each digital image downloaded in block 315. Extraction of the EXIF data is performed using known methods, and as such, a detailed description is omitted herein. The EXIF data includes, but is not limited to, a location tag indicating the location where a digital image was captured, a time and date tags indicating the time and date a digital image was captured, and a make and model tag of the image capture device that captured the digital image.

In block 325, location tags are extracted from the EXIF data. In one exemplary embodiment, the location may be presented as a city, a state, a country, etc. In another exemplary embodiment, the location may be presented as a latitude and longitude, which can be converted into a user friendly location name. The location tags are extracted using any known location tag extraction method.

In block 330, time and/or date tags are extracted from the EXIF data. The time and/or date tags are extracted using any known time/date tag extraction method. In block 335, make and/or model tags of the image capturing device with which the photo was taken are extracted from the EXIF data. The make/model tags are extracted using any known make/model tag extraction method. Flow then proceeds to block 355.

Once all of the tags have been extracted from the EXIF data and the top confident tags returned from image tagging service, all of the tags are stored in a database (not illustrated) in data storage server 770. In another exemplary embodiment, the tags are stored in a storage location remote from, but accessible by, the data storage server 770. The process then proceeds to block 400 in FIG. 5.

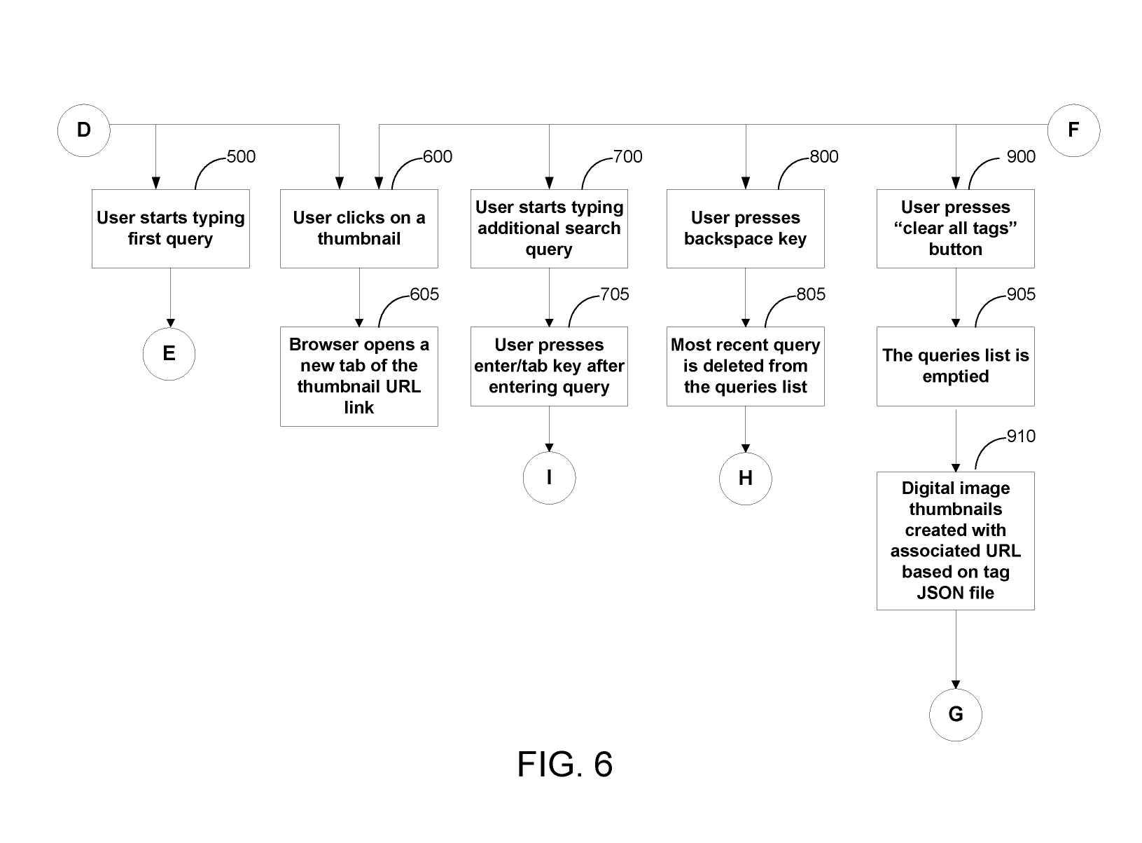

FIG. 5 illustrates an exemplary embodiment of the flow of creating thumbnails of digital images. After the tags are stored on the data storage server 770 in block 355 or after the system determines that the user is not selecting a new digital image storage service, the flow moves to block 400. In block 400, the tag JavaScript Object Notation (JSON) file, which is a file associated with the tags of the digital images, is received from the data storage server 770. Then, in block 405, digital image thumbnails are created along with an associated URL, according to the received tag JSON file. Finally, in block 410, the digital image thumbnails are displayed on the browser on client device 780. Blocks 400, 405, and 410 are carried out via known processing methods, and as such, detailed descriptions of each block are omitted herein. The flow then moves to blocks 500 and 600 in FIG. 6.

FIG. 6 illustrates an exemplary embodiment of generating and modifying search queries according to aspects of the present disclosure following creation of the digital image thumbnails displayed in the browser in block 410.

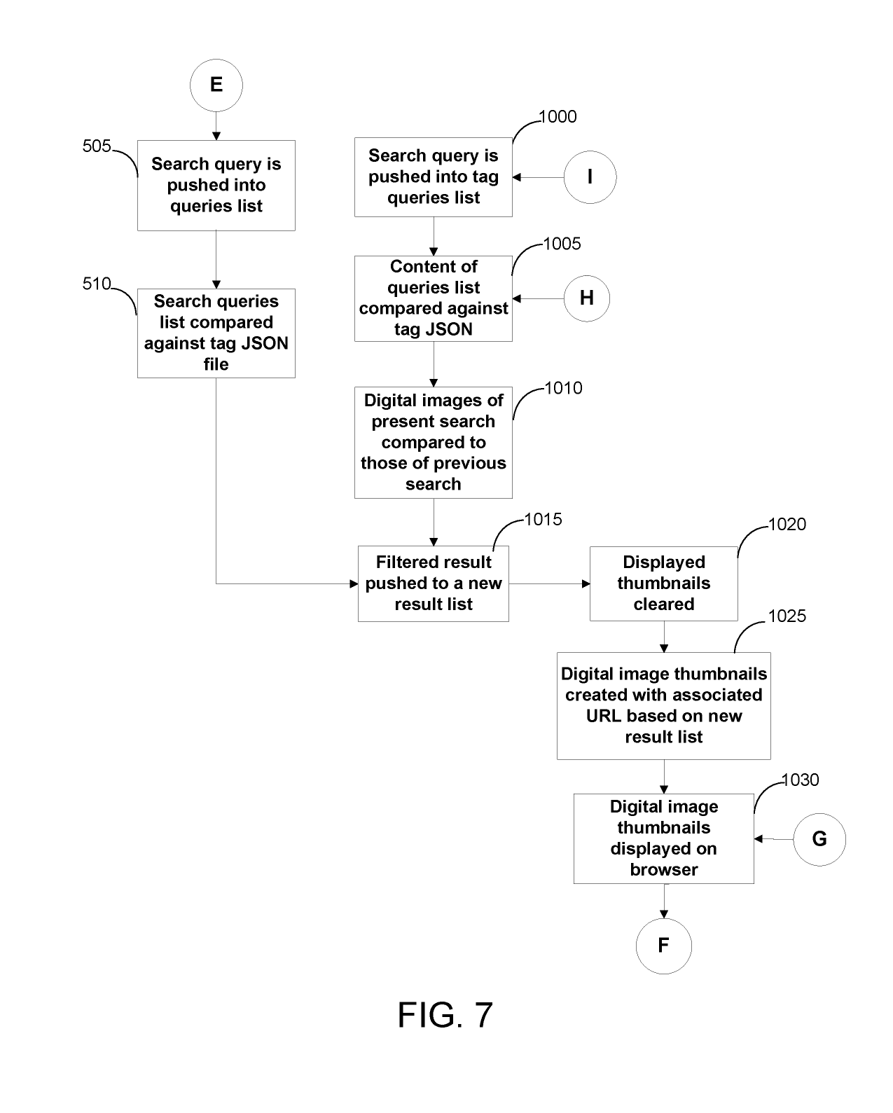

Turning to block 500, the user enters a first search query at client device 780 to initiate a search for a specific digital image or specific digital images from among the digital images displayed in the browser. Flow then proceeds to block 505 in FIG. 7, which is described below.

Blocks 600 and 605 in FIG. 6 enable the user to view one or more digital images by selecting the corresponding thumbnail(s) of the digital image(s) to be viewed. Viewing of the selected digital images is done via the digital image storage server 770, and as this is not a necessary element associated with aspects of the present disclosure, a detailed description of blocks 600 and 605 are omitted herein

FIG. 7 illustrates an exemplary embodiment of the flow of selecting and displaying digital images based on a search query. After the user enters a first search query in block 500 of FIG. 6, in block 505, the search query list generator module 784 pushes/adds the entered query into a queries list. Then, in block 510, the contents of the queries list, e.g., the terms that make up each of the queries in the queries list, is compared against the tag JSON file received in block 400. This comparison is performed by the filtered result generator module 785, and the result is a list of digital images whose tags match the terms of the search query. Next, in block 1015, the filtered result from block 510 is pushed/added to an updated/ new queries result list.

In block 1020, the thumbnails displayed in block 410 are cleared. Clearing of the thumbnails is done via known methods, and as such, a detailed description is omitted herein. Then in block 1025, the digital image thumbnails associated with the contents of the results list obtained in block 1015 are generated with their associated URL by the thumbnail creator module 786. In block 1030, the thumbnails generated in block 1015 are displayed on the browser of client device 780. The flow then returns to FIG. 6, where blocks 600, 700, 800, or 900 can be selected.

With respect to block 600, after the thumbnails are displayed in the browser of client device 780 in block 1030, blocks 600 and 605 as described above can be repeated.

In block 700, the user can further refine the search initiated in block 500 by generating an additional search query. After the search query is generated in block 700, in block 705, the user initiates/submits the query. For example, initiation/submission of the search query can be triggered by selection of the “Enter” or “Tab” keys on a keyboard (not shown) connected to client device 780. Use of the “Enter” or “Tab” key is just an example of a technique that can be used to initiate/submit a search query. Any other technique that would enable a user to initiate/submit a search query is applicable to the aspects of the present disclosure. The process then proceeds to block 1000 in FIG. 7, which is described below.

In block 800, the user can initiate a process for updating the queries list generated in block 505 or block 1000 (described below). In the present exemplary embodiment, the process is initiated by the user selecting/pressing a “backspace” key on a keyboard (not shown) connected to client device 780. Use of the “backspace” key is just an example of one technique that can used to initiate updating the queries list. Any other technique, method, process, etc. that would enable a user to initiate updating the queries list is applicable to the aspects of the present disclosure.

In block 805, as a result of the user's action in block 800, the most recent search query added to the search query list, e.g., in block 505 as described above or in block 1000 as described below, is deleted from the query list. Flow then proceeds to block 1005 in FIG. 7 as described below.

While block 800 as described above enables the user to delete the most recent query from the search query list, block 900 enables the user to initiate a procedure for deleting all of the queries in the search query list. In the present exemplary embodiment, the user initiates the procedure by selecting a “Clear All Tags” button (not shown) on a display (not shown) associated with client device 780. Use of the “Clear All Tags” button is just an example of one technique that can be used to initiate clearing all of the queries in the search query list. Any other technique, method, process, etc. that would enable a user to initiate clearing all of the queries in the search query list is applicable to the aspects of the present disclosure.

In block 905, as a result of the user's action in block 900, all of the queries in the search query list are cleared. Next, in block 910, the digital image thumbnails generated in block 405 are re-created. The process then proceeds to block 1030 in Fig, 7, which is described below.

Returning to FIG. 7, following the user initiating/submitting the query in block 705, in block 1000, the search query is pushed/added into the queries list. The flow then proceeds to block 1005, where contents of the queries list, e.g., the terms that make up each of the queries in the queries list, is compared against the tag JSON file received in block 400. This comparison is performed by the filtered result generator module 785, and the result is a list of digital images whose tags match the terms of the search queries.

Next, in block 1010, the digital images of the present search are compared against digital images from a previous search, and the result of the comparison is the digital images matching all of the tags associated with the search queries. The comparison is accomplished using known methods, and as such, a detailed description is omitted herein. Flow then proceeds to blocks 1015-1030, which were previously described above.

Any applicable computer-readable medium (e.g., a magnetic disk (including a floppy disk, a hard disk), an optical disc (including a CD, a DVD, a Blu-ray disc), a magneto-optical disk, a magnetic tape, and semiconductor memory (including flash memory, DRAM, SRAM, a solid state drive, EPROM, EEPROM)) can be employed as a computer-readable medium for the computer-executable instructions. The computer-executable instructions may be stored on a computer-readable storage medium that is provided on a function-extension board inserted into a device or on a function-extension unit connected to the device, and a CPU provided on the function-extension board or unit may implement at least some of the operations of the above-described embodiments.

Furthermore, some embodiments use one or more functional units to implement the above-described devices, systems, and methods. The functional units may be implemented in only hardware (e.g., customized circuitry) or in a combination of software and hardware (e.g., a microprocessor that executes software).

We claim:

1. A method for searching digital images comprising
receiving a first search query;
determining a first set of digital images based on the contents of the first query;
displaying the digital images returned based on the results of the first query;
receiving a second query different from the first query;
determining a second set of digital images based on the contents of the first query and the second query; and
displaying the digital images returned based on the results of the first query and second query.

2. The method according to claim 1, wherein
determining the first set of digital images includes selecting, from a storage device, a set of images from a plurality of stored images each having at least one characteristic associated therewith that matches at least one term of the first search query.

3. The method according to claim 2, wherein
determining the second set of digital images includes selecting from the first set of digital images, images having at least one additional characteristic associated therewith that matches at least one term of the second search query.

4. The method according to claim 1, wherein
each digital image includes at least one characteristic associated therewith and further includes a confidence value indicating a degree of accuracy with which the at least one characteristic describes a context of each image and, further comprises
determining the first set of images by comparing the first search query with the at least one characteristic associated with each digital image and selecting, for the first set of images, digital images having the at least one characteristic with a confidence value equal to or greater than a predetermined threshold.

5. The method according to claim 4, further comprising
determining the second set of images by comparing the second search query with the at least one characteristic associated with each digital image of the first set of images and selecting, for the second set of images, digital images having the at least one characteristic with a confidence value equal to or greater than a predetermined threshold.

6. The method according to claim 1, further comprising
automatically selecting from the second set of images an further set of images in response to receipt of a further search query, wherein the further search query includes the first and second search queries; and
continually updating the displayed images in the user interface to include the further set of images each time a further search query is received.

7. The method according to claim 1, further comprising
deleting, at least one term from at least one of the first search query and second search query;
determining a further set of images by deleting, from the first and second set of images, images having an image characteristic corresponding to the deleted at least one term; and
displaying the further set of images.

8. The method according to claim 1, wherein
determining the first set of images includes,
searching at least one data file stored in memory using at least one term of the first search query, the at least one data file including
an image identifier associated with each of the stored images that identifies an image and a location of an image in a storage device; and
at least one image tag corresponding to at least one characteristic of the stored image;
selecting at least one image for the first set of images in response to determining that the at least one term of the first search query matches one of the at least one image tags; and
for each image selected for the first set of images, storing, in memory, the image identifier and the at least one image tag associated with the selected image.

9. The method according to claim 8, wherein
displaying the first set of images includes, generating, for each image selected for the first set of images, a thumbnail of the selected image, the generated thumbnail including the image identifier and the at least one image tag enabling a user to select the generated thumbnail for full size display using the image identifier.

10. The method according to claim 8, wherein
determining the second set of images includes,
searching the memory including the image identifiers and at least one image tags of each image selected for the first set of images; and
selecting an image for the second set of images in response to determining that the at least one term of the second search query matches one of the at least one image tags of an image in the first set of images.

11. An apparatus comprising:
a memory storing instructions; and
at least one processor that, upon execution of the stored instructions is controlled to perform operations comprising:
receiving a first search query;
determining a first set of digital images based on the contents of the first query;
displaying the digital images returned based on the results of the first query;
receiving a second query different from the first query;
determining a second set of digital images based on the contents of the first query and the second query; and
displaying the digital images returned based on the results of the first query and second query.

12. The apparatus according to claim 11, wherein executing the stored instructions controls the at least one processor to perform operations including
determining the first set of digital images includes selecting, from a storage device, a set of images from a plurality of stored images each having at least one characteristic associated therewith that matches at least one term of the first search query.

13. The apparatus according to claim 12, wherein executing the stored instructions controls the at least one processor to perform operations including
determining the second set of digital images includes selecting from the first set of digital images, images having at least one additional characteristic associated therewith that matches at least one term of the second search query.

14. The apparatus according to claim 11, wherein executing the stored instructions controls the at least one processor to perform operations including
each digital image includes at least one characteristic associated therewith and further includes a confidence value indicating a degree of accuracy with which the at least one characteristic describes a context of each image and, further comprises
determining the first set of images by comparing the first search query with the at least one characteristic associated with each digital image and selecting, for the first set of images, digital images having the at least one characteristic with a confidence value equal to or greater than a predetermined threshold.

15. The apparatus according to claim 14, wherein executing the stored instructions controls the at least one processor to perform operations including
determining the second set of images by comparing the second search query with the at least one characteristic associated with each digital image of the first set of images and selecting, for the second set of images, digital images having the at least one characteristic with a confidence value equal to or greater than a predetermined threshold.

16. The apparatus according to claim 11, wherein executing the stored instructions controls the at least one processor to perform operations including
automatically selecting from the second set of images an further set of images in response to receipt of a further search query, wherein the further search query includes the first and second search queries; and
continually updating the displayed images in the user interface to include the further set of images each time a further search query is received.

17. The apparatus according to claim 11, wherein executing the stored instructions controls the at least one processor to perform operations including
deleting, at least one term from at least one of the first search query and second search query;
determining a further set of images by deleting, from the first and second set of images, images having an image characteristic corresponding to the deleted at least one term; and
displaying the further set of images.

18. The apparatus according to claim 11, wherein executing the stored instructions controls the at least one processor to perform operations including
determining the first set of images includes,
searching at least one data file stored in memory using at least one term of the first search query, the at least one data file including
an image identifier associated with each of the stored images that identifies an image and a location of an image in a storage device; and
at least one image tag corresponding to at least one characteristic of the stored image;
selecting at least one image for the first set of images in response to determining that the at least one term of the first search query matches one of the at least one image tags; and
for each image selected for the first set of images, storing, in memory, the image identifier and the at least one image tag associated with the selected image.

19. The apparatus according to claim 11, wherein executing the stored instructions controls the at least one processor to perform operations including
displaying the first set of images includes, generating, for each image selected for the first set of images, a thumbnail of the selected image, the generated thumbnail including the image identifier and the at least one image tag enabling a user to select the generated thumbnail for full size display using the image identifier.

20. The apparatus according to claim 19, wherein executing the stored instructions controls the at least one processor to perform operations including
determining the second set of images includes,
searching the memory including the image identifiers and at least one image tags of each image selected for the first set of images; and
selecting an image for the second set of images in response to determining that the at least one term of the second search query matches one of the at least one image tags of an image in the first set of images.

21. A non-transitory computer readable medium storing instructions that, when executed by at least one processor, controls the processor to perform operations including:
receiving a first search query;
determining a first set of digital images based on the contents of the first query;
displaying the digital images returned based on the results of the first query;
receiving a second query different from the first query;
determining a second set of digital images based on the contents of the first query and the second query; and
displaying the digital images returned based on the results of the first query and second query.
